(19) United States
(12) Patent Application Publication
(10) Pub. No.: US 2024/0275895 A1
(43) Pub. Date: Aug. 15, 2024

(54) IMAGE PROCESSING APPARATUS, NON-TRANSITORY COMPUTER READABLE MEDIUM STORING PROGRAM, AND IMAGE PROCESSING METHOD

(71) Applicant: FUJIFILM BUSINESS INNOVATION CORP., Tokyo (JP)

(72) Inventors: Yuto SHIONO, Kanagawa (JP); Yuki TSUCHITOI, Kanagawa (JP); Manabu HAYASHI, Kanagawa (JP); Shigeru TAMURA, Kanagawa (JP); Kanade KUBOTA, Kanagawa (JP); Yuki IGUCHI, Kanagawa (JP)

(73) Assignee: FUJIFILM BUSINESS INNOVATION CORP., Tokyo (JP)

(21) Appl. No.: 18/364,618

(22) Filed: Aug. 3, 2023

(30) Foreign Application Priority Data
Feb. 10, 2023 (JP) 2023-019348

(51) Int. Cl. H04N 1/00

(52) U.S. Cl. CPC H04N 1/00777; H04N 1/00408; H04N 1/00474; H04N 1/00684; H04N 1/00771

(57) ABSTRACT

An image processing apparatus includes a processor configured to, in a case of controlling an image capturer to image a document placed in a placement area without an instruction from a user in response to detection of placement of the document in the placement area, avoid imaging of the document placed in the placement area if the document placed in the placement area is identical to a document imaged last time.

### CROSS-REFERENCE TO RELATED APPLICATIONS

This application is based on and claims priority under 35 USC 119 from Japanese Patent Application No. 2023-019348 filed Feb. 10, 2023.

### BACKGROUND

### (i) Technical Field

The present disclosure relates to an image processing apparatus, a non-transitory computer readable medium storing a program, and an image processing method.

### (ii) Related Art

Japanese Unexamined Patent Application Publication No. 2018-157424 describes a document scanner. Coordinates of four corners of a book document are stored. If a difference between current coordinates of the four corners of the book document and previous coordinates of the four corners is equal to or smaller than a threshold, determination is made that page transition is made in the book document, and imaging is performed. If the difference is larger than the threshold, determination is made that the book document is changed, and the job is terminated.

### SUMMARY

In an image processing apparatus, an image capturer automatically images a placement area in response to detection of placement of a document in the placement area. If the user leaves the document in the placement area, unintended imaging may be repeated.

Aspects of non-limiting embodiments of the present disclosure relate to an image processing apparatus, a non-transitory computer readable medium storing a program, and an image processing method. In the image processing apparatus in which the image capturer automatically images the placement area in response to detection of placement of a document in the placement area, repetition of unintended imaging may be prevented even if the user leaves the document.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing apparatus comprising a processor configured to, in a case of controlling an image capturer to image a document placed in a placement area without an instruction from a user in response to detection of placement of the document in the placement area, avoid imaging of the document placed in the placement area if the document placed in the placement area is identical to a document imaged last time.

### BRIEF DESCRIPTION OF THE DRAWINGS

An exemplary embodiment of the present disclosure will be described in detail based on the following figures, wherein:

FIG. 1A is a side view of the appearance of an image forming apparatus according to an exemplary embodiment of the present disclosure;

FIG. 1B is a front view of the appearance of the image forming apparatus according to the exemplary embodiment of the present disclosure;

FIG. 2 is a top view of the appearance of a placement area with a document reading device not in use;

FIG. 3 is a top view of the appearance of the placement area with the document reading device in use;

FIG. 4 is a block diagram illustrating the hardware configuration of the image forming apparatus;

FIG. 5 is a block diagram illustrating the functional configuration of the image forming apparatus;

FIG. 6 illustrates an example of a live view screen;

FIG. 7 illustrates an example of a preview screen;

FIG. 8 illustrates an example of a notification message;

FIG. 9 illustrates an example of a selection screen;

FIG. 10 illustrates an example of a function screen; and

FIG. 11 is a flowchart illustrating a flow of a process for document imaging in the image forming apparatus.

### DETAILED DESCRIPTION

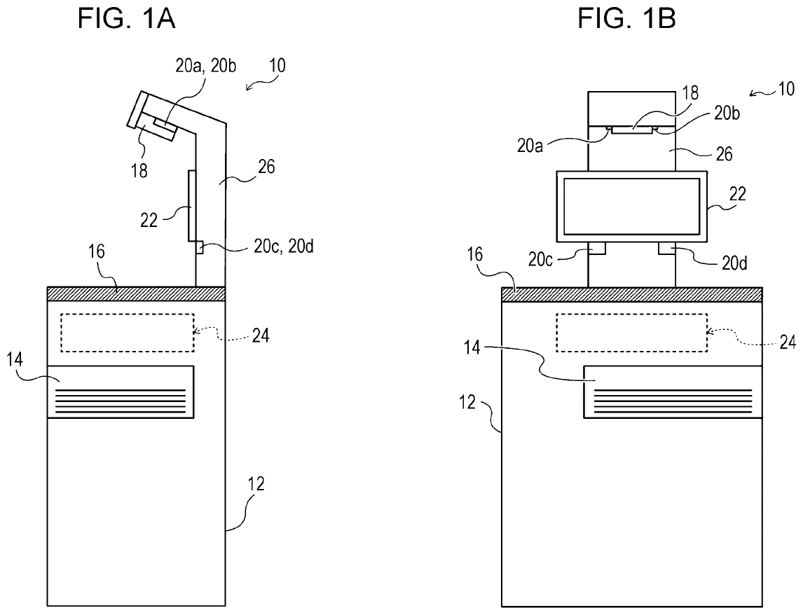

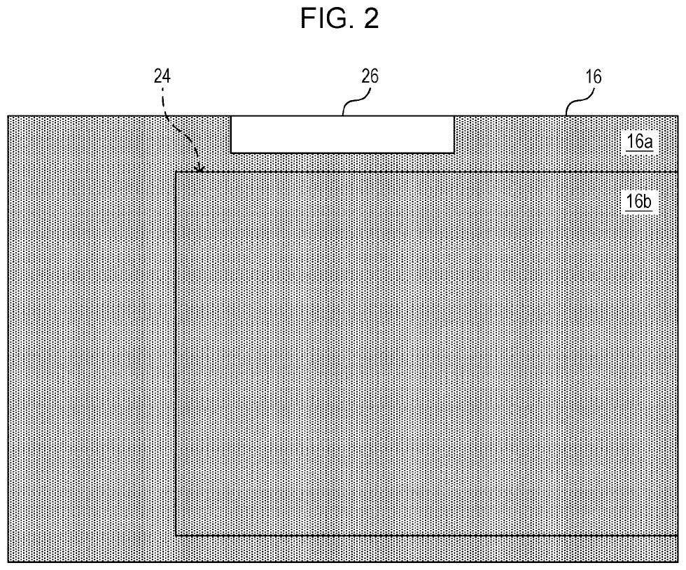

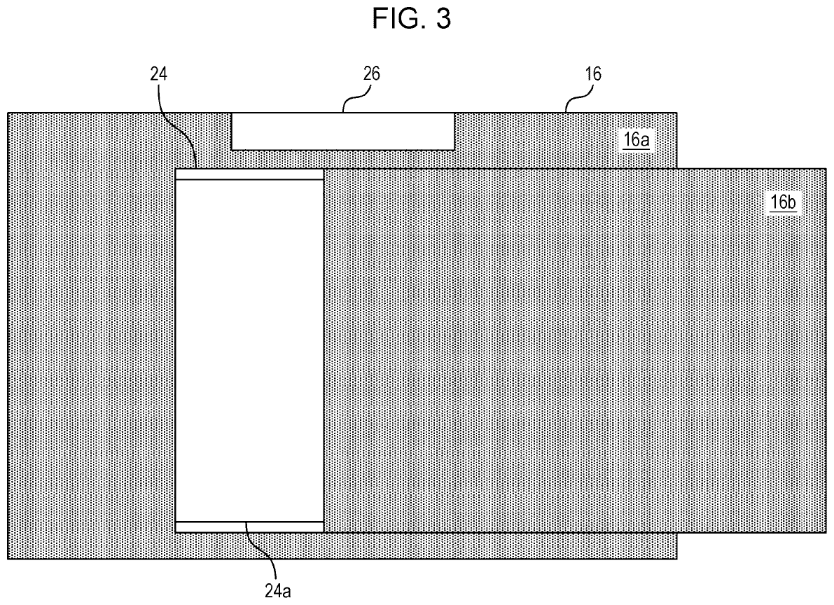

An exemplary embodiment of the present disclosure is described in detail with reference to the drawings. FIGS. 1A and 1B illustrate the appearance of an image forming apparatus 10 that is an example of an image processing apparatus according to the exemplary embodiment of the present disclosure. FIG. 1A is a side view of the image forming apparatus 10. FIG. 1B is a front view of the image forming apparatus 10. FIG. 2 is a top view of the appearance of a placement area 16 with a document reading device 24 not in use. FIG. 3 is a top view of the appearance of the placement area 16 with the document reading device 24 in use. Examples of the image forming apparatus 10 include a multifunction peripheral installed in an office.

As illustrated in FIG. 1, the image forming apparatus 10 includes an apparatus body 12, an exit tray 14 serving as a medium exit, the placement area 16, an imaging device 18, a light radiation device 20 including four light sources 20a, 20b, 20c, and 20d, an operation panel 22, and the document reading device 24.

Paper that is an example of a medium is output to the exit tray 14. The exit tray 14 is provided at a position where a standing user may pick up the medium.

The placement area 16 serves as the top surface of the apparatus body 12, and is disposed above the apparatus body 12. The placement area 16 is mounted above the exit tray 14 in a vertical direction. The apparatus body 12 below a top plate 16a of the placement area 16 includes the document reading device 24.

As illustrated in FIG. 2, a document such as paper, a business card, or a receipt may be placed on the top plate 16a of the placement area 16. As illustrated in FIG. 3, the document reading device 24 may be used by sliding a slider 16b that is a part of the top plate 16a of the placement area 16 outward in a plane direction.

The document reading device 24 includes a document feeding mechanism and a scanner. The document reading device 24 takes in a document placed in a document placement area 24a exposed by sliding the slider 16b outward in the plane direction, and reads the document. The document reading device 24 may simultaneously read both sides of the document.

The imaging device 18 includes an imaging element such as a charge coupled device (CCD), and acquires image data by imaging a subject such as a document. The imaging device 18 is mounted above the placement area 16, and images the document placed in the placement area 16 from the top. Assuming that the top surface of the placement area 16 is a reference plane, the phrase “above the placement area 16” means not only a vertically upper side of the reference plane but also an upper position in the vertical direction that is higher than the reference plane.

A support column 26 is provided on a far side on the top surface of the apparatus body 12, that is, the top surface of the placement area 16. The support column 26 extends substantially upright from the top surface of the placement area 16, and its end is bent to a position above the placement area 16. The imaging device 18 is mounted at the end of the support column 26.

An image former that forms an image of a subject placed in the placement area 16 is provided between the exit tray 14 and the placement area 16. That is, the image former that forms an image on paper to be output to the exit tray 14 is provided above the exit tray 14.

The light radiation device 20 includes one or more light sources such as light emitting diodes (LEDs). For example, the light radiation device 20 includes the light sources 20a, 20b, 20c, and 20d. The light sources 20a, 20b, 20c, and 20d are provided on the support column 26. That is, the light sources 20a, 20b, 20c, and 20d are provided above the placement area 16.

Specifically, the light sources 20a and 20b are provided near the imaging device 18 and oriented downward on both sides of the imaging device 18 on the support column 26. The light sources 20c and 20d are provided near the operation panel 22 and oriented obliquely downward on both sides of the support column 26 at the lower end of the operation panel 22.

That is, the light sources 20a and 20b and the light sources 20c and 20d are positioned at different heights from the placement area 16. In other words, the light sources 20a, 20b, 20c, and 20d are positioned at different angles of light to be radiated onto a subject, and radiate light in different directions toward a document.

The operation panel 22 includes a display screen, and is used to make settings on the image forming apparatus 10. The operation panel 22 is mounted on the support column 26 between the placement area 16 and the imaging device 18 on a far side of the apparatus body 12.

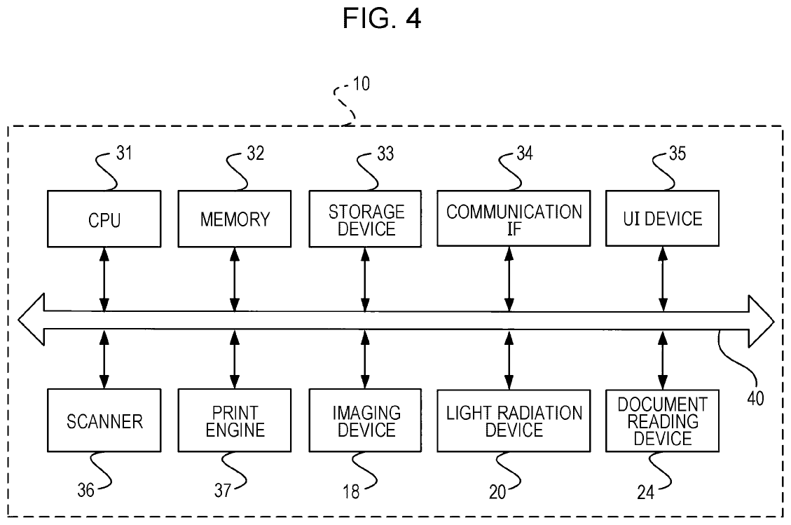

The hardware configuration of the image forming apparatus 10 of this exemplary embodiment is described. FIG. 4 is a block diagram illustrating the hardware configuration of the image forming apparatus 10.

As illustrated in FIG. 4, the image forming apparatus 10 includes a CPU 31, a memory 32, a storage device 33 such as a hard disk drive, a communication interface (IF) 34 that transmits data to and receives data from an external apparatus or the like via a network, a user interface (UI) device 35 including a touch panel or a liquid crystal display and a keyboard, a scanner 36, a print engine 37, the imaging device 18, the light radiation device 20, and the document reading device 24. Those components are connected to each other via a control bus 40.

The communication IF 34 transmits data to and receives data from an external apparatus or the like. The UI device 35 receives instructions input by a user. The scanner 36 reads a document placed on the image forming apparatus 10 to generate image data. The print engine 37 prints an image on a recording medium such as print paper through charging, exposing, developing, transferring, and fixing steps.

The CPU 31 is a processor that performs predetermined processes based on a control program stored in the memory 32 or the storage device 33 to control operation of the image forming apparatus 10. In this exemplary embodiment, the CPU 31 reads and executes the control program stored in the memory 32 or the storage device 33, but the control program may be provided by being recorded in a computer readable recording medium. For example, the program may be provided by being recorded in an optical disc such as a compact disc (CD) read only memory (ROM) or a digital versatile disc (DVD) ROM, or in a semiconductor memory such as a universal serial bus (USB) memory or a memory card. The control program may be acquired from an external apparatus via a communication line connected to the communication IF 34.

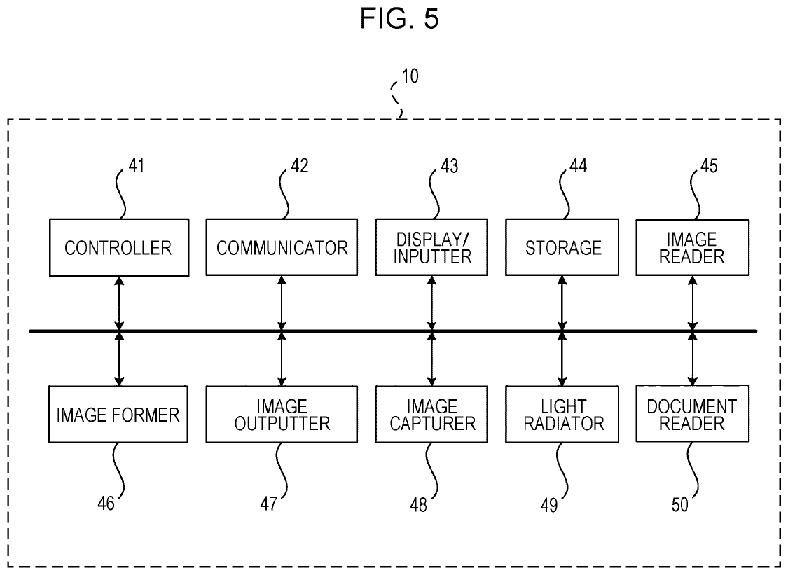

The functional configuration of the image forming apparatus 10 of this exemplary embodiment is described. FIG. 5 is a block diagram illustrating the functional configuration of the image forming apparatus 10.

As illustrated in FIG. 5, the image forming apparatus 10 includes a controller 41, a communicator 42, a display/inputter 43, a storage 44, an image reader 45, an image former 46, an image outputter 47, an image capturer 48, a light radiator 49, and a document reader 50.

The controller 41 controls the overall operation of the image forming apparatus 10. The controller 41 controls not only light emission of the document reading device 24 but also, for example, document imaging of the imaging device 18 and output of print data such as a document image by the image outputter 47 based on instructions input by the user.

The communicator 42 transmits data to and receives data from an external apparatus. The display/inputter 43 displays various types of information on the display screen of the operation panel 22 under control of the controller 41. The display/inputter 43 receives various types of operation information input by the user on the operation panel 22. The operation panel 22 serving as the display/inputter 43 is an example of a display in the technology according to the exemplary embodiment of the present disclosure. The storage 44 stores the control program and various types of data such as image data generated by the controller 41.

The image reader 45 performs a scanning operation for reading various documents under control of the controller 41. The image former 46 forms an image to be output by the image outputter 47 under control of the controller 41. The image outputter 47 outputs an image formed by the image former 46 onto a recording medium such as print paper under control of the controller 41. The image outputter 47 is an example of a document outputter in the technology according to the exemplary embodiment of the present disclosure.

The image capturer 48 images a document placed in the placement area 16 by using the imaging device 18. The light radiator 49 illuminates the placement area 16 by using the light radiation device 20. The document reader 50 automatically reads a document placed in the placement area 16 by using the document reading device 24.

In the image forming apparatus 10 of this exemplary embodiment, the controller 41 controls the image capturer 48 to automatically image the placement area 16 in response to detection of placement of a document in the placement area 16.

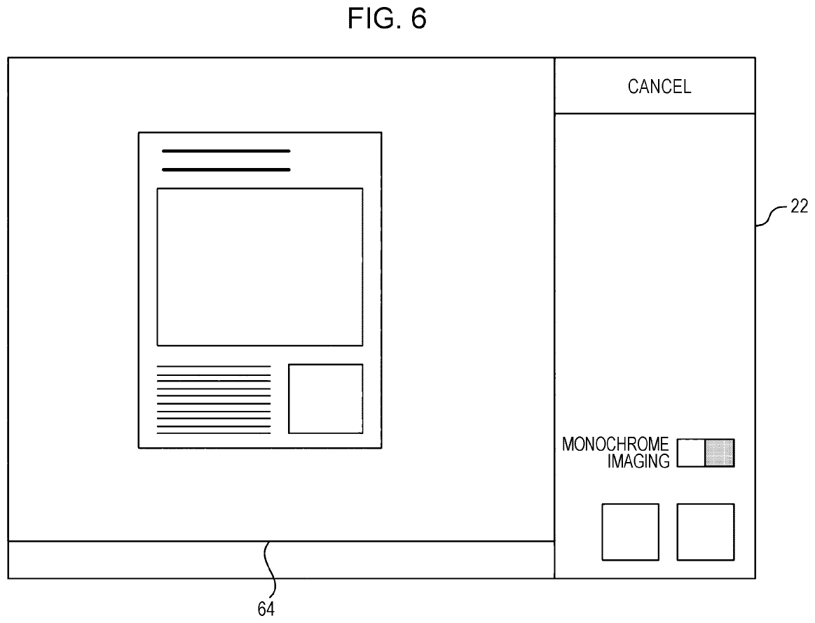

Specifically, the controller 41 causes the operation panel 22 to display a live view screen as illustrated in FIG. 6 in response to detection of placement of a document in the placement area 16 in a standby state for imaging in the imaging function of the image capturer 48, such as “Auto-scan & print” described later. The live view screen displays a live view image 64 captured by the image capturer 48 and showing a current state.

If the position of the document placed in the placement area 16 does not change for a preset period or longer, the controller 41 causes the image capturer 48 to image the placement area 16.

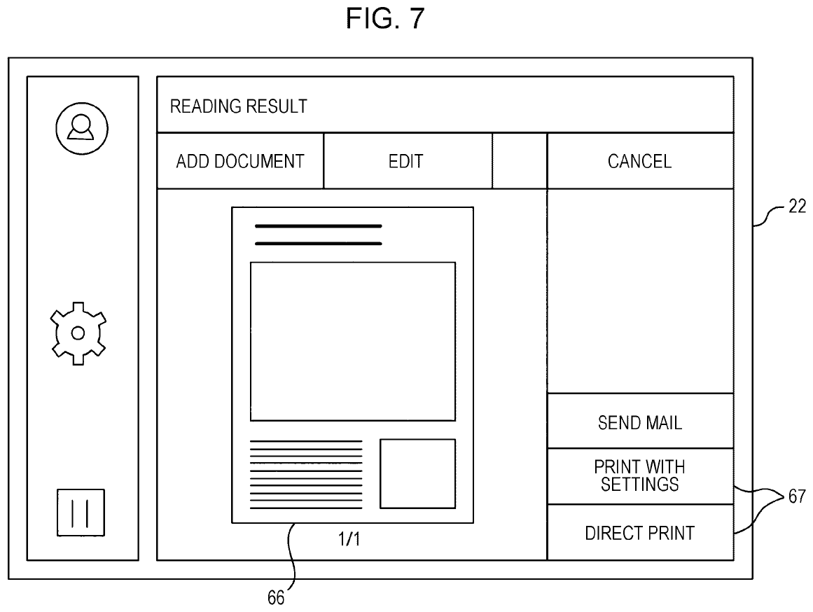

After the imaging, the controller 41 causes the operation panel 22 to display a preview screen as illustrated in FIG. 7. The preview screen displays an image 66 of the document captured by the image capturer 48. The preview screen includes various buttons 67 that are an instruction operator for “Send mail”, an instruction operator for “Print with settings”, and an instruction operator for “Direct print”.

In response to selection of any one of the buttons 67 on the preview screen, the controller 41 performs a process of the function set for the selected button, and then makes transition to the standby state for imaging. If there is no operation on the preview screen for a preset period, the controller 41 makes transition to the standby state for imaging without performing the process of the function.

If the user leaves the document in the placement area 16 in this configuration, the left document may be imaged against the user's intention, and the unintended imaging may be repeated.

In view of this, the controller 41 does not perform imaging of a document placed in the placement area 16 if the document is identical to the document imaged last time.

Specifically, a document placed in the placement area 16 is automatically imaged and the image 66 of the document is displayed on the preview screen as described above. At this stage, the image 66 of the document is recorded in the storage 44 as a comparative image for detecting the left document. The recorded comparative image may be the latest image acquired by the automatic imaging.

When the automatic imaging is newly performed, an image of a document acquired by the new automatic imaging is compared with the comparative image, and determination is made as to whether the document placed in the placement area 16 is identical to the document imaged last time. The determination need not be made if no comparative image is recorded in the storage 44 as in a case where the automatic imaging was not performed in the past in the image forming apparatus 10 or the recorded comparative image has been reset.

In this exemplary embodiment, there is no particular limitation on the method for determining, by the controller 41, whether the document placed in the placement area 16 is identical to the document imaged last time. For example, the determination may be made by using the amount of change in the position of the document in the image captured by the image capturer 48, the amount of change in the contents of the document in the image captured by the image capturer, or a combination of the two types of amount.

In the case of the determination using the amount of change in the position of the document, the positions of four corners of the image of the document captured by the image capturer 48 may be compared with the positions of four corners of the image of the document captured last time by the image capturer 48, and determination may be made that the document placed in the placement area 16 is identical to the document imaged last time if the positions of both the documents are completely the same or the amount of change in the positions is equal to or smaller than a preset threshold.

In the case of the determination using the amount of change in the contents of the document, the contents of the image of the document captured by the image capturer 48 may be compared, by image recognition, with the contents of the document imaged last time by the image capturer 48, and determination may be made that the document placed in the placement area 16 is identical to the document imaged last time if the contents of both the documents are completely the same or the amount of change in the contents is equal to or smaller than a preset threshold.

In the case of the combination of the determination using the amount of change in the position of the document and the determination using the amount of change in the contents of the document, determination may be made that the document placed in the placement area 16 is identical to the document imaged last time if the position of the document has changed and the contents of the document have not changed. Determination may be made that the documents are not identical if the position of the document has not changed and the contents of the document have changed.

The controller 41 may give a notification that the imaging of the document placed in the placement area 16 is suspended if the document is identical to the document imaged last time. There is no particular limitation on the notification that the imaging of the document is suspended. The notification may be given by any method such as voice, an image, or an LED indicator.

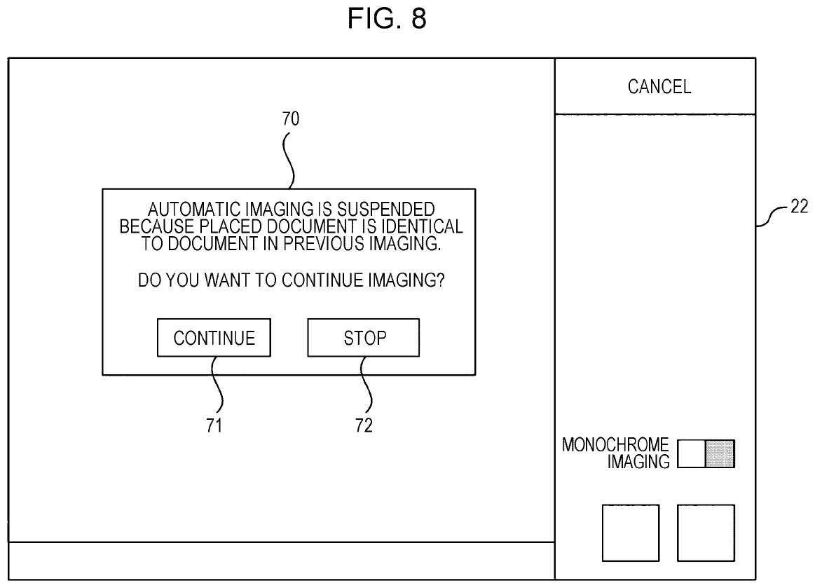

In the case of the notification given by an image, the display/inputter 43 may display a message 70 indicating that the document imaging is suspended, such as a message “Automatic imaging is suspended because placed document is identical to document in previous imaging.” as illustrated in FIG. 8.

In this case, the controller 41 may cause the display to display the information indicating that the document imaging is suspended together with operators for inputting information indicating whether to continue the imaging.

For example, as illustrated in FIG. 8, a “continue” button 71 that is an operator for inputting continuation of the imaging and a “stop” button 72 that is an operator for inputting confirmation of the stop of the imaging may be displayed on the display/inputter 43 together with the message 70.

If the document placed in the placement area 16 is identical to the document imaged last time, the controller 41 may cause the display/inputter 43 to display an image other than the live view screen.

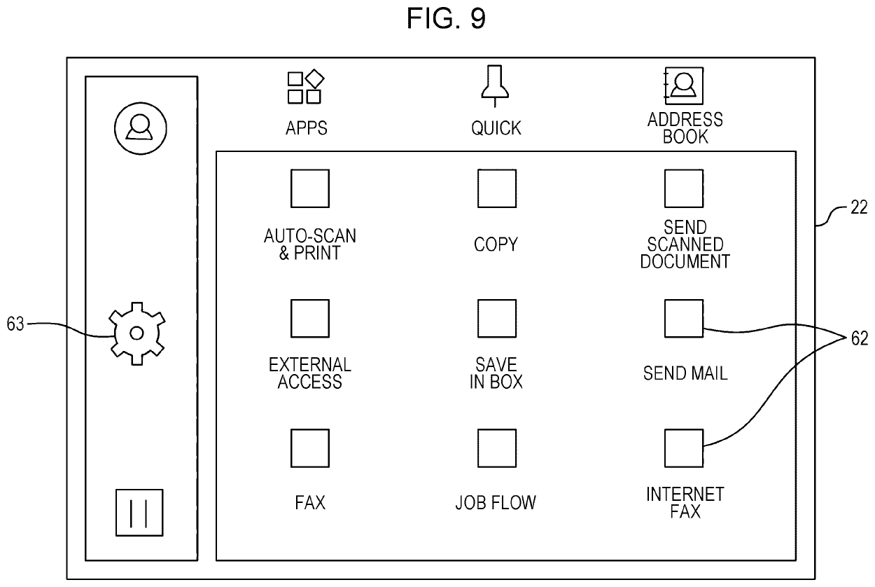

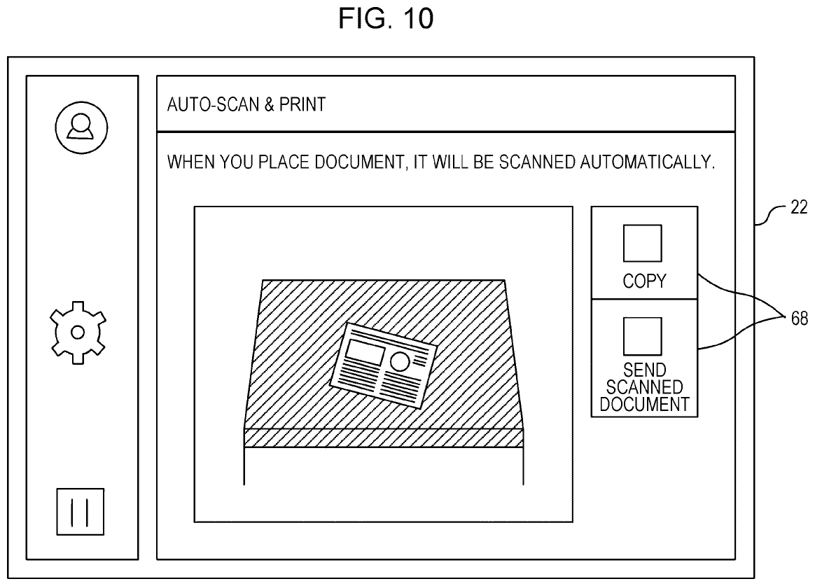

In this case, the image other than the live view screen may be a selection screen for prompting the user to select a function to be used as illustrated in FIG. 9, or a function screen for use of the imaging function of the image capturer 48 as illustrated in FIG. 10.

As illustrated in FIG. 9, the selection screen includes a plurality of buttons 62 to be used for selecting a function to be used. In the example illustrated in FIG. 9, the selection screen includes buttons 62 of “Auto-scan & print”, “Copy”, “Send scanned document”, “External access”, “Save in box”, “Send mail”, “Fax”, “Job flow”, “Internet fax”, “Apps”, “Quick”, and “Address book”. The selection screen also includes a setting button 63 and other buttons to which various functions are assigned.

The “Auto-scan & print” function is to automatically image a document placed in the placement area 16 and send a mail or print the document. This function uses the image capturer 48 and the image outputter 47. The “Copy” function is to read a document placed in the placement area 16 by the document reading device 24 and print the read document. This function uses the document reader 50 and the image outputter 47. The “Address book” function is to edit the list of addresses. The setting button 63 is used for selecting a function to make setting of the apparatus.

As illustrated in FIG. 10, the function screen for use of “Auto-scan & print” that is an example of the imaging function of the image capturer 48 includes buttons 68 of “Copy” and “Send scanned document” for an image acquired by automatic imaging.

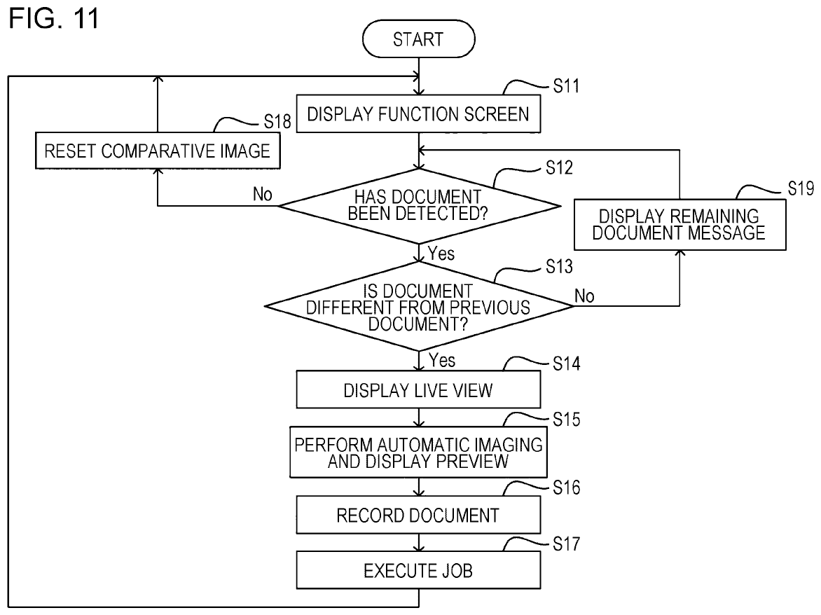

A process for document imaging in the image forming apparatus 10 of this exemplary embodiment is described with reference to a flowchart of FIG. 11.

In Step S11, the controller 41 causes the display/inputter 43 to display the function screen of “Auto-scan & print”.

In Step S12, the controller 41 determines whether placement of a document in the placement area 16 is detected.

If determination is made in Step S12 that the placement of a document is not detected, the controller 41 resets a comparative image (i.e., an image of a document captured last time) in Step S18, and proceeds to Step S11.

If determination is made in Step S12 that the placement of a document is detected, the controller 41 determines in Step S13 whether the document placed in the placement area 16 is different from the document imaged last time.

If determination is made in Step S13 that the document placed in the placement area 16 is identical to (i.e., not different from) the document imaged last time, the controller 41 causes, in Step S19, the display/inputter 43 to display a message indicating that document imaging is suspended, and proceeds to Step S12.

If determination is made in Step S13 that the document placed in the placement area 16 is different from the document imaged last time, the controller 41 causes the display/inputter 43 to display a live view screen in Step S14.

In Step S15, the controller 41 performs automatic imaging on the document and causes the display/inputter 43 to display a preview screen.

The controller 41 records the document in Step S16, executes a job selected by the user in Step S17, terminates the series of processes, and proceeds to Step S11 again.

### Modification

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The exemplary embodiment of the present disclosure is applied to the multifunction peripheral as the image processing apparatus, but may be applied to various image processing apparatuses such as a scanner.
The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image processing apparatus comprising:
a processor configured to, in a case of controlling an image capturer to image a document placed in a placement area without an instruction from a user in response to detection of placement of the document in the placement area, avoid imaging of the document placed in the placement area if the document placed in the placement area is identical to a document imaged last time.
   (((2)))

The image processing apparatus according to (((1))), wherein the processor is configured to determine whether the document placed in the placement area is identical to the document imaged last time by using an amount of change in a position of the document in an image captured by the image capturer.

(((3)))

The image processing apparatus according to (((2))), wherein the processor is configured to determine whether the document placed in the placement area is identical to the document imaged last time by using an amount of change in contents of the document in the image captured by the image capturer.

(((4)))

The image processing apparatus according to (((1))), wherein the processor is configured to determine whether the document placed in the placement area is identical to the document imaged last time by using an amount of change in contents of the document in an image captured by the image capturer.

(((5)))

The image processing apparatus according to any one of (((1))) to (((4))), wherein the processor is configured to give a notification that the imaging of the document placed in the placement area is suspended if the document placed in the placement area is identical to the document imaged last time.

(((6)))

The image processing apparatus according to (((5))), wherein the processor is configured to cause a display to display information indicating that the imaging of the document placed in the placement area is suspended together with an operator to be used for inputting information indicating whether to continue the imaging.

(((7)))

The image processing apparatus according to any one of (((1))) to (((6))), wherein the processor is configured to cause a display to display an image other than an image captured by the image capturer and showing a current state if the document placed in the placement area is identical to the document imaged last time.

(((8)))

The image processing apparatus according to (((7))), wherein the image other than the image captured by the image capturer and showing the current state is a selection screen for prompting the user to select a function to be used or a function screen for use of an imaging function of the image capturer.

(((9)))

A program causing a computer to execute a process comprising:
avoiding, in a case of controlling an image capturer to image a document placed in a placement area without an instruction from a user in response to detection of placement of the document in the placement area, imaging of the document placed in the placement area if the document placed in the placement area is identical to a document imaged last time.

What is claimed is:

1. An image processing apparatus comprising:
a processor configured to, in a case of controlling an image capturer to image a document placed in a placement area without an instruction from a user in response to detection of placement of the document in the placement area, avoid imaging of the document placed in the placement area if the document placed in the placement area is identical to a document imaged last time.

2. The image processing apparatus according to claim 1, wherein the processor is configured to determine whether the document placed in the placement area is identical to the document imaged last time by using an amount of change in a position of the document in an image captured by the image capturer.

3. The image processing apparatus according to claim 2, wherein the processor is configured to determine whether the document placed in the placement area is identical to the document imaged last time by using an amount of change in contents of the document in the image captured by the image capturer.

4. The image processing apparatus according to claim 1, wherein the processor is configured to determine whether the document placed in the placement area is identical to the document imaged last time by using an amount of change in contents of the document in an image captured by the image capturer.

5. The image processing apparatus according to claim 1, wherein the processor is configured to give a notification that the imaging of the document placed in the placement area is suspended if the document placed in the placement area is identical to the document imaged last time.

6. The image processing apparatus according to claim 5, wherein the processor is configured to cause a display to display information indicating that the imaging of the document placed in the placement area is suspended together with an operator to be used for inputting information indicating whether to continue the imaging.

7. The image processing apparatus according to claim 1, wherein the processor is configured to cause a display to display an image other than an image captured by the image capturer and showing a current state if the document placed in the placement area is identical to the document imaged last time.

8. The image processing apparatus according to claim 7, wherein the image other than the image captured by the image capturer and showing the current state is a selection screen for prompting the user to select a function to be used or a function screen for use of an imaging function of the image capturer.

9. A non-transitory computer readable medium storing a program causing a computer to execute a process comprising:
avoiding, in a case of controlling an image capturer to image a document placed in a placement area without an instruction from a user in response to detection of placement of the document in the placement area, imaging of the document placed in the placement area if the document placed in the placement area is identical to a document imaged last time.

10. An image processing method comprising:
avoiding, in a case of controlling an image capturer to image a document placed in a placement area without an instruction from a user in response to detection of placement of the document in the placement area, imaging of the document placed in the placement area if the document placed in the placement area is identical to a document imaged last time.
